(19) United States
(12) Patent Application Publication
(10) Pub. No.: US 2026/0112120 A1
(43) Pub. Date: Apr. 23, 2026

(54) VOLUMETRIC SCENE RECONSTRUCTION WITH VARIABLE VOXEL RESOLUTION IN TRUNCATED SIGNED DISTANCE FUNCTION (TSDF) FUSION

(71) Applicant: Niantic Spatial, Inc., San Francisco, CA (US)

(72) Inventors: David Zuñiga Noël, London (GB); Daniel Knoblauch, Kirkland, WA (US); Victor Adrian Prisacariu, Oxford (GB)

(21) Appl. No.: 18/919,404

(22) Filed: Oct. 17, 2024

(51) Int. Cl. G06T 17/20; G06T 7/12; G06T 7/20; G06V 10/764

(52) U.S. Cl. CPC G06T 17/205; G06T 7/12; G06T 7/20; G06V 10/764; G06V 2201/07

(57) ABSTRACT

A system performs polygon mesh generation with a variable-resolution truncated signed distance function (TSDF) grid. The system receives image data capturing a real-world environment and captured by a camera assembly of a client device. The system applies a depth estimation model to each frame to output a depth map. The system applies a semantic segmentation model to each frame to output a segmentation mask. The system determines level hints for each frame based on the segmentation mask and the depth map. The level hints indicate a voxel resolution level per pixel of the frame. The system generates a variable-resolution truncated signed distance function (TSDF) grid by fusing depth predictions from the depth maps. The variable-resolution TSDF grid includes voxels at different resolution levels. The system extracts a mesh from the grid digitally representing surfaces in the real-world environment. The mesh may be augmented with patterns from the image data.

### BACKGROUND

The application relates to the technical field of computer vision.

In modern digital infrastructures, image-based volumetric scene reconstruction, e.g., with a truncated signed distance function (TSDF), is an efficient approach in spatial modeling of real-world environments captured in image data by camera assemblies. The spatial model may be used for other device functionality, e.g., presenting augmented reality content, generating a virtual representation of the physical environment. However, disparate portions of the environment are of differing importance. For example, faraway objects or the ground do not require high resolution, but objects of interest or objects with complex geometries or textures may stand to benefit from the higher resolution. A one-size fits all resolution is deficient in this regard, thereby creating a technical challenge. Moreover, even if the entire scene is represented at the highest resolution, that would create unnecessary expenditure of computing resources on objects that would not benefit from the increased granularity and precision.

Moreover, implementing variable voxel resolution is a non-trivial and rather technically challenging endeavor. A TSDF volume, parsed into voxels, is used to generate a polygon mesh representing physical objects. With higher resolution TSDF volume comes more accurate polygon meshes is representing the physical object. However, creating a polygon mesh from voxels of varying resolution is technically challenging. There remains a need for improvements to empower the use of variable voxel resolution.

### SUMMARY

A system performs polygon mesh generation with a variable-resolution truncated signed distance function (TSDF) grid. The system receives image data capturing a real-world environment and captured by a camera assembly of a client device. The system applies a depth estimation model to each frame to output a depth map. The system applies a semantic segmentation model to each frame to output a segmentation mask. The system determines level hints for each frame based on the segmentation mask and the depth map. The level hints indicate a voxel resolution level per pixel of the frame. The system generates a variable-resolution truncated signed distance function (TSDF) grid by fusing depth predictions from the depth maps. The variable-resolution TSDF grid includes voxels at different resolution levels. The variable resolution voxels focuses the system's resources in computing more complex meshes for significant or important features in the real-world environment, while defocusing on lower priority surfaces. For example, the system can use higher resolution voxels to provide for more accurate spatial representations of key objects in the scene, whereas compromising on accuracy of the spatial representation of the ground. The system extracts a mesh from the grid digitally representing surfaces in the real-world environment. The mesh may be augmented with patterns from the image data.

With the completed polygon mesh, the system may store the mesh for subsequent recall. Another client device may request to access or view the polygon mesh to simulate being physically present in the real-world environment. The system may recall the polygon mesh from a database and transmit the polygon mesh for presentation on the client device. In other embodiments, the system may leverage the polygon mesh in generating virtual content to augment into image data.

### BRIEF DESCRIPTION OF THE DRAWINGS

FIG. 1 depicts a representation of a virtual world having a geography that parallels the real world, according to one or more embodiments.

FIG. 2 depicts an exemplary interface of a parallel reality game, according to one or more embodiments.

FIG. 3 is a block diagram of a networked computing environment suitable for image-based localization with an ensemble of calibrated localization models, according to one or more embodiments.

FIG. 4 is a flowchart illustrating polygon mesh generation with a variable-resolution TSDF grid, according to one or more embodiments.

FIG. 5 is a method flowchart describing polygon mesh generation with a variable-resolution TSDF grid, according to one or more embodiments.

FIG. 6A illustrates an example variable-resolution TSDF grid, according to one or more example implementations.

FIG. 6B illustrates an example polygon mesh generated based on the example variable-resolution TSDF grid of FIG. 6A, according to one or more example implementations.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where VPS-based pose verification is desirable. In addition, the inherent flexibility of computer-based systems allows for a great variety of possible configurations, combinations, and divisions of tasks and functionality between and among the components of the system.

Various embodiments relate to the spatial modeling of a real-world environment with image data captured by a camera assembly (e.g., on a mobile computing device). A mapping system may leverage a depth estimation model to generate depth maps for the frames of the image data. The mapping system may leverage other models to infer other contextual data from the image data (e.g., object detection, semantic segmentation, surface orientation, etc.). The mapping system may build a variable-resolution voxel grid based on image data and, optionally the contextual data. In generating the variable-resolution voxel grid, the mapping system may enforce neighboring voxels to be within one resolution level difference. As additional image data is collected (e.g., in real-time), the mapping system may modify voxel resolution at one or more portions of the environment. The mapping system performs truncated signed distance function (TSDF) fusion to extract a topography mesh of the spatial environment from the variable-resolution voxel grid. The mapping system may further pattern the polygon mesh based on the image data. With the polygon mesh, the mapping system may store the mesh for subsequent retrieval.

The polygon mesh may be used in many virtual reality, augmented reality, or mixed reality applications. For example, in an augmented reality context, the polygon mesh may be used to inform placement of virtual objects into the physical real-world environment. This may be particularly advantageous when virtual objects are presented as interacting with the physical real-world environment. For example, the polygon mesh of the environment may inform behaviors of the virtual elements, e.g., virtual elements cannot move through a surface of the polygon mesh. In another example, the polygon mesh can inform when a virtual element is occluded or disoccluded by an object in the real-world. Correspondingly, the virtual elements may be rendered to simulate the occlusion and disocclusion. In another example, the polygon mesh may be used to build a parallel virtual world that corresponds to the real world. A player may navigate the virtual world, e.g., with an avatar or character, while interacting with elements in the virtual world.

### Example Location-Based Parallel Reality Game

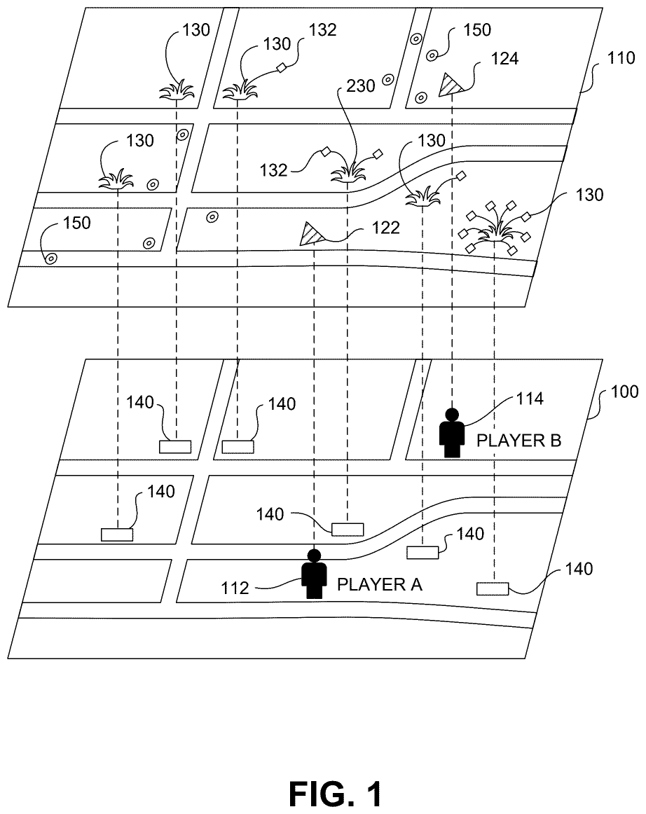

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110. In one or more embodiments, portions of the virtual world 110 may include polygon meshes mirroring environments of the real world 100. These polygon meshes may be generated by a mapping system based on image data captured by a camera assembly (e.g., from a mobile computing device).

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100. In one or more embodiments, as the player traverses a portion of the virtual world 110, the player's device may render that portion with a polygon mesh extracted from a variable-resolution voxel grid generated from image data of the real-world environment.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

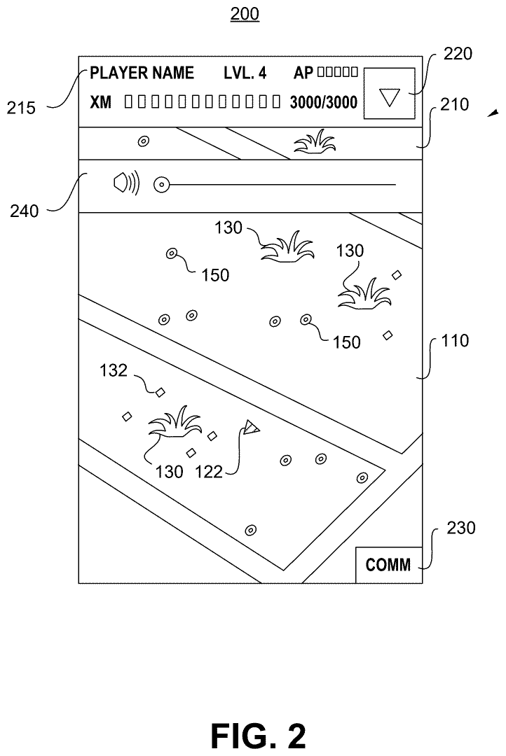

FIG. 2 depicts one or more embodiments of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a mobile device (e.g., a smart phone) and moving about in the real world with the mobile device. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

To generate the visual representation, a game server can generate and maintain a virtual map, e.g., that corresponds to the real-world environment. To generate the virtual map, the game server may collect image data from mobile devices of the physical environment. With the image data, the game server can create digital spatial models describing the physical environment. For example, the game server may leverage volumetric scene reconstruction algorithms to generate the spatial models from the image data (or pose data). In other embodiments, when generating virtual elements in an augmented reality context, the game server may perform localization to identify a pose of the mobile device. With the pose in hand, the game server can accurately identify positions to generate the virtual elements to augment the image data captured by the mobile device.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

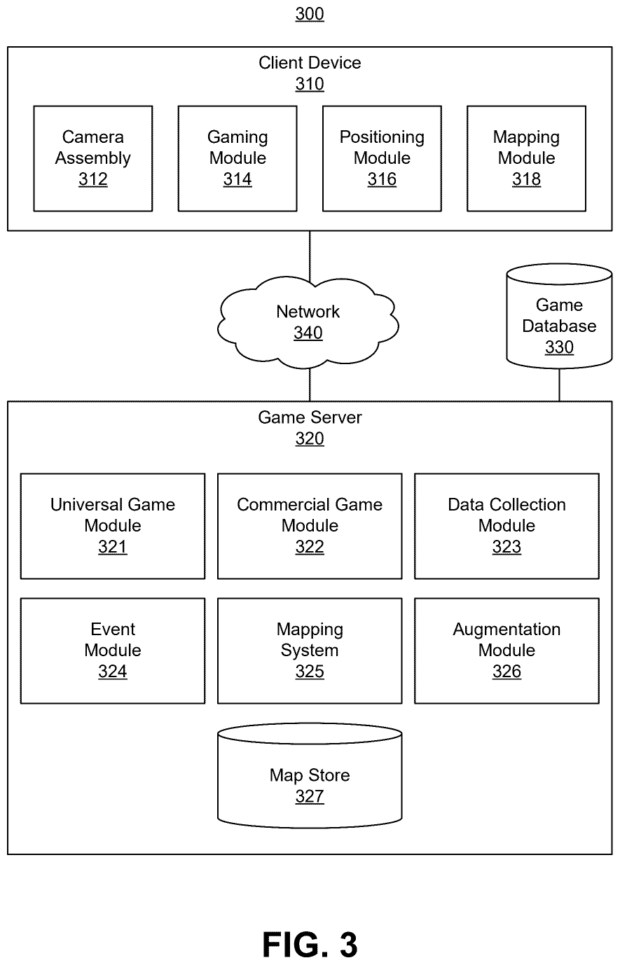

FIG. 3 illustrates one or more embodiments of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. In instances with the AR headset, the client device 310 may present a spatial map (e.g., inclusive of a polygon mesh) of a real-world environment to provide for an immersive simulation of being physically located at the real-world environment corresponding to the polygon mesh. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one or more embodiments, the client device 310 includes a camera assembly 312, a gaming module 314, a positioning module 316, and a mapping module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one or more embodiments, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

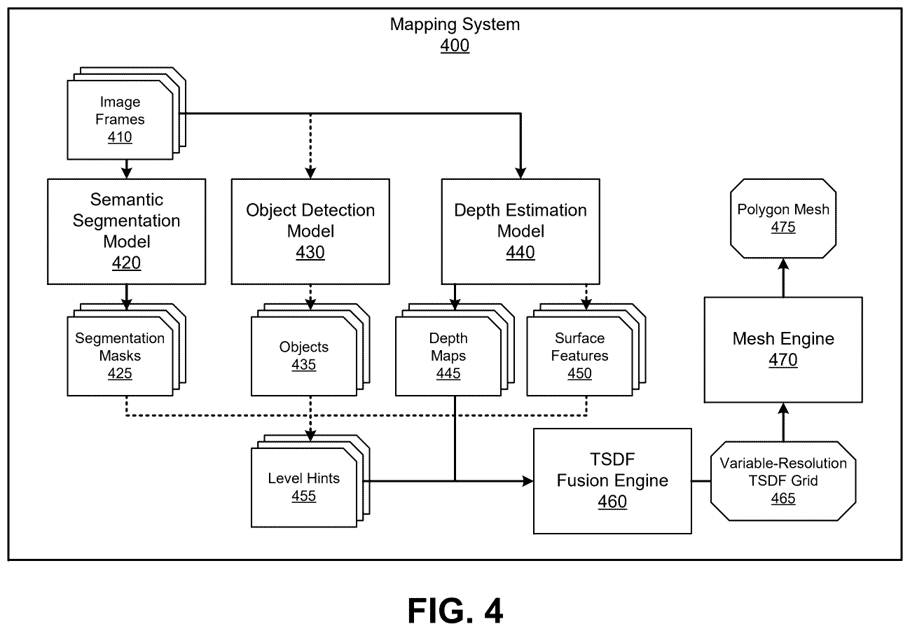

The mapping module 318 maintains a map of the virtual world. The mapping module 318 may aid in generation of portions of the map of the virtual world. The map may include the topology terrain of the virtual world (e.g., in parallel to the real world), virtual objects (e.g., including objects representing real-world objects), landmarks, paths, labels, etc. In one or more embodiments, the map may include polygon meshes of different real-world environments. In such embodiments, the mapping module 318 may generate and/or update polygon meshes based on image data captured by the camera assembly 312. In other embodiments, the mapping module 318 may retrieve polygon meshes from the game server 320 previously generated by the game server 320 or other client devices 310 in past instances. Polygon mesh generation is further described under the game server 320 and in FIG. 4. Based on the retrieved maps of the virtual world, the mapping module 318 (or other modules of the client device 310) may generate game content to present to the user in conjunction with the virtual map retrieved. For example, the game content may include virtual elements or virtual characters placed within the virtual world. The user (e.g., via their avatar or character) may interact with the virtual elements or virtual characters.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, a map of the virtual world (including polygon meshes of real-world environments), etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one or more embodiments, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 322, a data collection module 323, an event module 324, a mapping module 325, an augmentation module 326, and a map store 327. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 322 can be separate from or a part of the universal game module 321. The commercial game module 322 can manage the inclusion of various game features within the parallel reality game that are linked with a commercial activity in the real world. For instance, the commercial game module 322 can receive requests from external systems such as sponsors/advertisers, businesses, or other entities over the network 370 to include game features linked with commercial activity in the real world. The commercial game module 322 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 323 can be separate from or a part of the universal game module 321. The data collection module 323 can manage the inclusion of various game features within the parallel reality game that are linked with a data collection activity in the real world. For instance, the data collection module 323 can modify game data stored in the game database 330 to include game features linked with data collection activity in the parallel reality game. The data collection module 323 can also analyze data collected by players pursuant to the data collection activity and provide the data for access by various platforms.

The event module 324 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping module 325 generates a map of the virtual world. In generating a map of the virtual world, the mapping module 325 may generate portions of the map corresponding to geographical real-world environments based on image data (e.g., captured by camera assemblies 312 of client devices 310). The map may be three-dimensional, e.g., represented by a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one or more embodiments, the mapping module 325 stores the 3D map along with any semantic/contextual information in the map store 327. The 3D map may be stored in the map store 327 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

In one or more embodiments, the mapping module 325 generates and/or updates polygon meshes corresponding to a real-world environment. The mapping module 325 receives image data captured by a camera assembly (e.g., the camera assembly 312 of the client device 310). The mapping system leverages a depth estimation model to generate depth maps for the frames of the image data. The mapping system may leverage other models to infer other contextual data from the image data (e.g., object detection, semantic segmentation, surface orientation, etc.). The mapping system may build a variable-resolution voxel grid based on image data and, optionally the contextual data. In generating the variable-resolution voxel grid, the mapping system may enforce neighboring voxels to be within one resolution level difference. As additional image data is collected (e.g., in real-time), the mapping system may modify voxel resolution at one or more portions of the environment. The mapping system performs truncated signed distance function (TSDF) fusion to extract a topography mesh of the spatial environment from the variable-resolution voxel grid. The mapping system may further pattern the polygon mesh based on the image data. With the polygon mesh, the mapping system may store the mesh in the map store 327. In one or more embodiments, the mapping module 325 may further update polygon meshes with novel image data. In so doing, the mapping module 325 may update the voxel grid, e.g., modifying voxel resolution, may update the polygon mesh, e.g., based on additional data extracted from the novel image data, or some combination thereof.

The augmentation module 326 overlays virtual elements onto the real-world image data. The augmentation module 326 receives the real-world image data. Other modules may aid in localizing the player's client device 310 within the real world. Based on the location of the client device 310, the augmentation module 326 may retrieve portions of the map of the virtual world corresponding to the real world (including polygon meshes of real-world environments). The augmentation module 326 may overlay the virtual elements into the image data, informed by the map. For example, a virtual character overlaid into the image data may be presented as traversing the real-world environment, as informed by a polygon mesh corresponding to the real-world environment. In other embodiments, other users may view the polygon mesh crafted by the mapping module 325 in conjunction with the augmentation module 326. In such embodiments, other users (e.g., from around the world) may, in viewing the polygon mesh corresponding to a real-world environment, virtually experience other real-world environments not physically located at their present location.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Polygon Mesh Generation with a Variable-Resolution Voxel Grid

In one or more embodiments, one or more of the computing devices perform polygon mesh generation with a variable-resolution grid.

FIG. 4 is a flowchart illustrating polygon mesh generation with a variable-resolution TSDF grid, according to one or more embodiments. FIG. 4 is described as being performed by a mapping system 400 (e.g., the mapping module 318, or the mapping module 325). In other embodiments, another computing system may perform some or all of the steps in the polygon mesh generation with the variable-resolution voxel grid for TSDF fusion.

The mapping system 400 receives image data comprising image frames 410 of a real-world environment. The image data may be captured by a camera assembly (e.g., the camera assembly 312 of the client device 310). In one or more embodiments, the image frames 410 may be derived from video data captured by the camera assembly, where each frame has a different timestamp within the video data.

The mapping system 400 leverages one or more models to extract contextual information from the image frames 410. The mapping system 400 may leverage a semantic segmentation model 420, an object detection model 430, a depth estimation model 440, or some combination thereof. In other embodiments, the mapping system 400 may leverage additional computer-vision-based models for extracting contextual information from the image frames 410.

The semantic segmentation model 420 segments pixels in an image frame 410 into one of a plurality of semantic classifications. For example, in the context of image data captured of real-world environments, the semantic segmentation model 420 may classify between roads, sidewalks, buildings, vehicles, people, sky, objects, etc. The semantic segmentation model 420 is configured to input an image frame 410 and to output pixel classifications as a segmentation mask 425, where pixels may be differentially colored according to their classification.

In one or more embodiments, the semantic segmentation model 420 may be configured as a machine-learning model, e.g., as a convolutional neural network. To train the semantic segmentation model 420 as a machine-learning model, the mapping system 400 may leverage training image data with labeled segmentation masks for training in a supervised manner. To perform the training, the mapping system 400 inputs the training image data into the semantic segmentation model 420 to output segmentation masks, classifying the pixels into the various semantic classes. The mapping system 400 may score the output segmentation masks against the ground truth labeled segmentation masks. The mapping system 400 may adjust parameters of the semantic segmentation model 420 to optimize the score (e.g., minimizing a pixel-wise loss, or maximizing an objective function, etc.).

The object detection model 430 detects and classifies objects present in the image. As compared to the semantic segmentation model, different object types could be classified under the same semantic class. For example, different objects like bikes, scooters, cars, and buses might all be classified under the same semantic class label of moving objects. The object detection model 430 extracts additional information by detecting and classifying the various objects 435 in an image frame 410. In one or more embodiments, the object detection model 430 may track detected objects 435 across image frames 410. For example, the object detection model 430 may track the relative motion of a pedestrian, relative to the camera perspective.

In one or more embodiments, the object detection model 430 may be configured as a machine-learning model, e.g., as a convolutional neural network. To train the object detection model 430 as a machine-learning model, the mapping system 400 may leverage training image data with labeled objects in the scene for training in a supervised manner. To perform the training, the mapping system 400 inputs the training image data into the object detection model 430 to output detected objects in the training image data. In some embodiments, the object detection model 430 may draw bounding boxes around the objects. The mapping system 400 may score the detected objects against the ground truth labeled objects. The mapping system 400 may adjust parameters of the object detection model 430 to optimize the score (e.g., minimizing a pixel-wise loss, or maximizing an objective function, etc.).

The depth estimation model 440 predicts depths of pixels in an image frame 410 as a depth map 445. The depth represents a relative distance between a pixel in the image frame and the camera perspective. In one or more embodiments, the depth estimation model 440 may further output surface features 450, e.g., the surface features 450 may include surface orientations represented as normal vectors for detected surfaces in the image frames 410. The depth estimation model 440 may identify surfaces (e.g., by grouping pixels together having smooth depth transitions. For example, if two neighboring pixels have depth estimates within a minimum threshold, then the depth estimation model 440 may infer the two pixels are part of the same surface. If, on the other hand, two neighboring pixels have depth estimates above the minimum threshold, then the depth estimation model 440 may infer the two pixels as part of different surfaces.

In one or more embodiments, the depth estimation model 440 may be configured as a machine-learning model, e.g., as a neural network. To train the depth estimation model 440 as a machine-learning model in a supervised manner, the mapping system 400 may leverage training image data with ground truth depth maps. To perform the training, the mapping system 400 inputs the training image data into the depth estimation model 440 to output depth maps for the images. The mapping system 400 may score the output depth maps against the ground truth depth maps. The mapping system 400 may adjust parameters of the object detection model 430 to optimize the score (e.g., minimizing a pixel-wise loss, or maximizing an objective function, etc.). To train the depth estimation model 440 as a machine-learning model in a self-supervised manner, the mapping system 400 may project images onto one another based on predicted depth maps, then score the projections against the target images to evaluate the depth estimation model 440's depth predictions. Further details relating to self-supervised depth estimation training can be found in U.S. application Ser. No. 16/413,907 filed on May 16, 2019, U.S. application Ser. No. 16/864,743 filed on May 1, 2020, and U.S. application Ser. No. 17/545,201 filed on Dec. 8, 2021, all of which are incorporated by reference in their entirety.

The mapping system 400 determines level hints 455 that indicate a degree of interest in the pixels of the frames 410. Correspondingly, the mapping system 400 may generate the variable-resolution TSDF grid 465 to be of finer resolution for pixels associated with objects of higher interest, and, complementarily, coarser resolution for pixels associated with objects of lesser interest. The mapping system 400 may calculate level hints 455 based on the segmentation masks 425, objects 435 identified by the object detection model 430, the depth maps 445, the surface features 450 or some combination thereof. The mapping system 400 may leverage a heuristic approach, e.g., implementing a function that disparately weights contribution of the inputs to yield a single hint value for a pixel. A voxel is the three-dimensional (3D) analog of a pixel, representing volumetric information in 3D space. The level hints 455 represent a voxel resolution level for certain pixels in the image frames 410. For example, in crafting the variable-resolution voxel grid, the voxel grid may use 1, 2, 3, 4, or 5 different voxel resolution levels. Between two adjacent voxel resolution levels, the finer voxel resolution level splits the coarser voxel resolution level into 8 voxel cells, i.e., each dimension resolution is doubled.

A TSDF fusion engine 460 of the mapping system 400 inputs the level hints 455 and the depth maps 445 to output the variable-resolution TSDF grid 465. The grid is a 3D voxel grid having varying voxel resolution at different portions of the grid. The value at each voxel cell is a truncated signed distance function (TSDF) value, representing whether a surface (from the image frames 410) is nearer or farther from the voxel. Depth predictions from each depth map 445 in view of a particular voxel may provide a TSDF value at that particular voxel. The TSDF fusion engine 460 fuses, i.e., aggregates, one or more depth predictions for a particular voxel in determining the TSDF value. In generating the variable-resolution TSDF grid 465, the TSDF fusion engine 460 may enforce one or more constraints. One example constraint is requiring neighboring voxel cells to be at most one step difference in voxel resolution. Accordingly, with two neighboring voxel cells, the voxel resolution level cannot be a two-step difference.

In one or more embodiments, the TSDF fusion engine 460 may leverage a hyperparameter that dictates how many depth values from different depth maps 445 are fused together in determining the TSDF values per voxel. The hyperparameter may be linearly dependent on depth of a pixel in the depth map 455. For example, the hyperparameter would increase quantity of depth values included in the TSDF value fusion for objects further from the camera's perspective. The mapping system 400 may parametrically fit the hyperparameter curve to an error curve for depth estimates by the depth estimation model. In effect, the hyperparameter controls a maximum error for depth measurements to be fused. Depth measurements beyond the maximum error are discounted from the fusion process. In one or more embodiments, the TSDF fusion engine 460 further leverages a previously generated TSDF grid (e.g., in a prior time period). The TSDF fusion engine 460 can modify the TSDF grid based on the new data and correspondingly extracted contextual information.

The mesh engine 470 extracts a polygon mesh 475 from the variable-resolution TSDF grid 465. In one or more embodiments, the mesh engine 470 applies a marching cubes algorithm to extract the polygon mesh 475 from the variable-resolution TSDF grid 465. In performing the marching cubes algorithm, the mesh engine 470 may use a case table to determine the surface geometry of each voxel cell. Depending on the parity of TSDF values at the corners of the voxel cells, the mesh engine 470 can extract an orientation of the surface passing through the voxel. In other embodiments, the mesh engine 470 may apply a level set algorithm to parameterize the polygon mesh 475 using different level sets. The polygon mesh 475 is a 3D representation of the topology of the real-world environment formed by vertices, edges, and faces (formed by the vertices and edges).

In one or more embodiments, the mesh engine 470 may implement cross-resolution-level interpolation to smooth the polygon mesh 475 across voxel resolution level transitions. In one or more embodiments, the mesh engine 470 leverages linear interpolation and/or bilinear interpolation. Linear interpolation is used to interpolate along edges of the voxel grid. Linear interpolation interpolates values of the two nodes defining the edge of the voxel grid. Bilinear interpolation is used to interpolate in the centers of planes of the voxel grid. Bilinear interpolation interpolates values of the four nodes defining the plane of the voxel grid. Fine-to-coarse interpolation fills in values on the coarse side of the resolution transition. Coarse-to-fine interpolation is used to smooth the transition, preventing mismatched polygon surfaces forming at the border of the two different voxel resolutions.

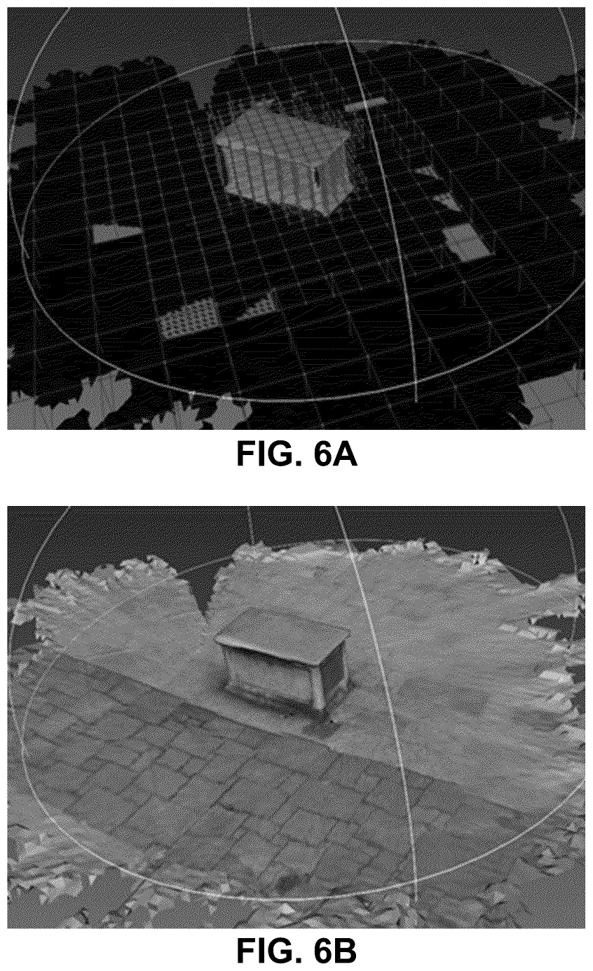

FIGS. 6A & 6B illustrate an example variable-resolution TSDF grid and an example polygon mesh, respectively, according to one or more example implementations. The variable-resolution voxel grid discretizes the 3D space of the real-world environment. As shown, different portions of the voxel grid are of differing resolution levels, e.g., as determined by the TSDF fusion engine 460 based on the level hints. In the example grid, the portion of the voxel grid overlapping an object of interest positioned towards a center of the voxel grid has a voxel resolution that is finer than portions of the grid overlapping the ground. FIG. 6A further illustrates how the segmentation masks influence level hints, and subsequently voxel resolution. The light gray portions of the real-world environment correspond to objects of interest, whereas the dark gray portions reflect the ground surface. FIG. 6B shows a polygon mesh generated from the variable-resolution TSDF grid. The polygon mesh uses polygons to represent the topology of the real-world environment. The polygon mesh may also have variable resolution corresponding to the variable-resolution TSDF grid. The polygon mesh may be augmented to include patterns of surfaces in the real-world environment. The polygon mesh is a digital representation of the real-world environment.

The system may provide functionality associated with the polygon mesh. In one or more embodiments, the system may generate virtual content including virtual elements that interact with the polygon mesh. For example, the system may generate a virtual character that traverses the digital environment, i.e., moving around the polygon mesh. In one or more embodiments, the system may generate navigational instructions for an autonomous agent. In such embodiments, the system may leverage the polygon mesh to determine a route to navigate the autonomous agent, e.g., based on the current position of the agent. In one or more embodiments, the system may also transmit the polygon mesh for presentation on a computing device. For example, a computing device may request accessing the digital representation of the real-world environment. The system may provide the polygon mesh to the computing device for presentation on the device. A user of the computing device may move around and view different parts of the digital representation. For example, as the user's position in the real-world changes (i.e., as measured by the positioning module 316), a perspective or point of view of the digital representation may also change corresponding to the user's movement in the real-world.

### Example Methods

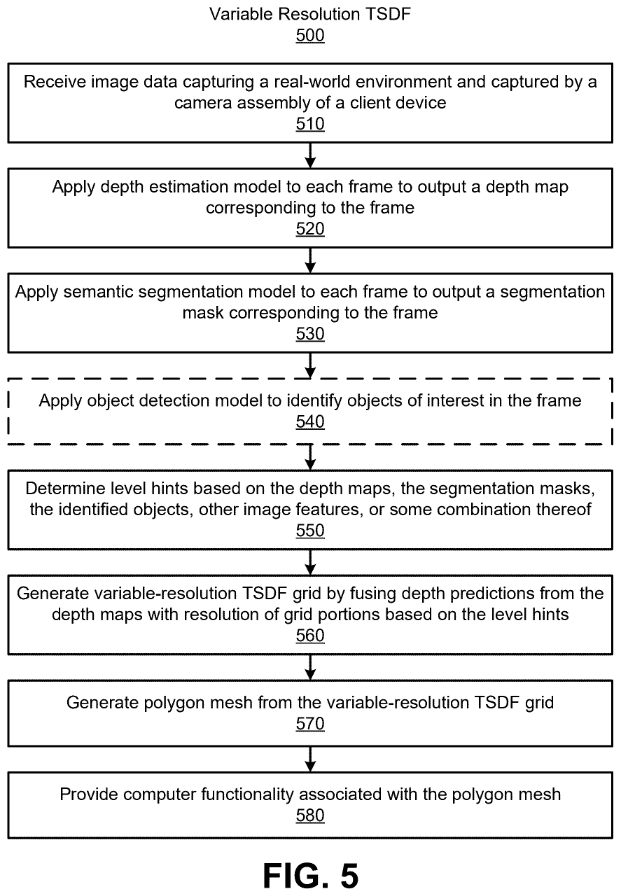

FIG. 5 is a method flowchart describing polygon mesh generation with a variable-resolution TSDF grid, according to one or more embodiments. The polygon mesh generation 500 with a variable-resolution TSDF grid is described as being performed by a system, which may be the client device 310 or the game server 320. In other embodiments, the steps of the polygon mesh generation 500 may be performed by one or more devices. In other embodiments, the polygon mesh generation 500 may include additional, fewer, or different steps than those listed.

The system receives 510 image data capturing a real-world environment and captured by a camera assembly of a client device. The image data may be continuous, or over separate sessions. The image data may be captured by a single camera or multiple cameras. In some embodiments, the system may perform image preprocessing to prepare the image data for polygon mesh generation.

The system applies 520 a depth estimation model to each frame to output a depth map corresponding to the frame. The depth estimation model may be configured as a monocular depth estimation model, e.g., configured to input at least one image frame and to output a depth map for the image frame. In some embodiments, the depth estimation model is further configured to identify surface orientation of one or more surfaces present in the frame. The depth estimation model may be configured as a machine-learning model.

The system applies 530 a semantic segmentation model to each frame to output a segmentation mask corresponding to the frame.

The system may apply 540 an object detection model to identify objects of interest in the frame. The object detection model may be trained as a machine-learning model in a supervised manner with training image data labeled with identified objects of interest. The object detection may further track the identified objects across the frames.

The system determines 550 level hints based on the depth maps, the segmentation masks, the identified objects of interest, other image features, or some combination thereof.

Other image features may include surface information, texture information, etc. The level hints indicate a voxel resolution level for each portion of the real-world environment. For example, the level hints may indicate that one portion of the real-world environment should be represented by voxels at a first resolution level, whereas the level hints may indicate that a second portion of the real-world environment should be represented by voxels at a second resolution.

The system generates 560 a variable-resolution TSDF grid by fusing depth predictions from the depth maps with resolution of grid portions based on the level hints. The variable-resolution TSDF grid comprises TSDF values indicating distance to a surface in the real-world environment The system may generate the variable-resolution TSDF grid by limiting neighboring voxel cells to be at most one voxel resolution level difference. In some embodiments, the system implements a hyperparameter that sets a quantity of depth predictions fused into the TSDF value per voxel, wherein the hyperparameter is fit to an error curve for depth predictions by the depth estimation model.

The system generates 570 a polygon mesh from the variable-resolution TSDF grid. In some embodiments, the system may interpolate between neighboring voxels of different voxel resolution. To do so, the system may interpolate both ways, from one neighboring voxel of lower resolution to another neighboring voxel of higher resolution, and from the higher resolution neighboring voxel to the lower resolution neighboring voxel. The system may further augment the polygon mesh with patterns from the real-world environment, represented in the image data. The system may map pixels in the image data to the polygon mesh based on the variable-resolution TSDF grid, the depth maps, or some combination thereof. The system may store the polygon mesh in a mapping database.

The system provides 580 functionality associated with the polygon mesh. In some embodiments, a second client device may request to view the polygon mesh. In response, the system may retrieve the polygon mesh and transmit the polygon mesh to the second client device. In one or more embodiments, the second client device may traverse around the polygon mesh. In some embodiments, the system may provide navigational instructions using the polygon mesh for an autonomous agent, e.g., to traverse the real-world environment. In some embodiments, the system may generate virtual content based on the polygon mesh, e.g., in hosting a parallel reality game. In such embodiments, the virtual elements (e.g., a non-playable character) may interact with the polygon mesh, effectively simulating the real-world environment.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one or more embodiments” or “an embodiment” means that a particular element, feature, structure, or characteristic described in connection with the embodiment is included in at least one or more embodiments. The appearances of the phrase “in one or more embodiments” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving image data capturing a real-world environment and captured by a camera assembly of a client device, the image data comprising a plurality of frames;
applying a depth estimation model to each frame to output a depth map corresponding to the frame, wherein the depth map comprises depth predictions for pixels in the frame;
applying a semantic segmentation model to each frame to output a segmentation mask corresponding to the frame, wherein the segmentation mask classifies pixels in the frame into one of a plurality of semantic classes;
determining level hints for each frame based on the segmentation mask and the depth map corresponding to the frame, wherein the level hints indicate a voxel resolution level for each pixel;
generating a variable-resolution truncated signed distance function (TSDF) grid by fusing depth predictions from the depth maps corresponding to the plurality of frames, the variable-resolution TSDF grid comprising TSDF values indicating distance to a surface in the real-world environment, wherein the variable-resolution TSDF grid includes at least one portion at a first voxel resolution level and another portion at a second voxel resolution level of finer resolution than the first voxel resolution level, and wherein the voxel resolution at each portion of the variable-resolution TSDF grid is based on the level hints;
generating a polygon mesh from the variable-resolution TSDF grid digitally representing surfaces in the real-world environment captured by the image data; and
storing the polygon mesh in a map database.

2. The computer-implemented method of claim 1, further comprising:
applying an object detection model to each frame to identify one or more objects in the frame; and
tracking one or more of the objects across frames;
wherein generating the variable-resolution TSDF grid is further based on the tracked one or more objects in the real-world environment.

3. The computer-implemented method of claim 2, wherein the object detection model is trained as a machine-learning model in a supervised manner with training image data labeled with identified objects.

4. The computer-implemented method of claim 1,
wherein applying the depth estimation model to each frame further comprises applying the depth estimation model to identify surface orientation of one or more surfaces present in the frame; and
wherein generating the variable-resolution TSDF grid is further based on the one or more surface orientations of the one or more surfaces.

5. The computer-implemented method of claim 1, wherein the depth estimation model is trained as a machine-learning model in a self-supervised manner by projecting frames from training image data onto other frames of the training image data based on depth predictions by the depth estimation model.

6. The computer-implemented method of claim 1, wherein generating the variable-resolution TSDF grid is constrained by limiting neighboring voxel cells to be at most one voxel resolution level difference.

7. The computer-implemented method of claim 1, wherein generating the variable-resolution TSDF grid comprises implementing a hyperparameter that sets a quantity of depth predictions fused into the TSDF value per voxel, wherein the hyperparameter is fit to an error curve for depth predictions by the depth estimation model.

8. The computer-implemented method of claim 1, wherein generating the polygon mesh from the variable-resolution TSDF grid comprises interpolating between neighboring voxels of different voxel resolution levels.

9. The computer-implemented method of claim 1, further comprising:
augmenting the polygon mesh with patterns from the image data corresponding to one or more surfaces represented by the polygon mesh.

10. The computer-implemented method of claim 1, further comprising:
receiving a request from a second client device to view the polygon mesh;
retrieving the polygon mesh from the map database; and
transmitting the polygon mesh to the second client device for presentation on the second client device.

11. A non-transitory computer-readable storage medium storing instructions that, when executed by a computer processor, cause the computer processor to perform operations comprising:
receiving image data capturing a real-world environment and captured by a camera assembly of a client device, the image data comprising a plurality of frames;
applying a depth estimation model to each frame to output a depth map corresponding to the frame, wherein the depth map comprises depth predictions for pixels in the frame;
applying a semantic segmentation model to each frame to output a segmentation mask corresponding to the frame, wherein the segmentation mask classifies pixels in the frame into one of a plurality of semantic classes;
determining level hints for each frame based on the segmentation mask and the depth map corresponding to the frame, wherein the level hints indicate a voxel resolution level for each pixel;
generating a variable-resolution truncated signed distance function (TSDF) grid by fusing depth predictions from the depth maps corresponding to the plurality of frames, the variable-resolution TSDF grid comprising TSDF values indicating distance to a surface in the real-world environment, wherein the variable-resolution TSDF grid includes at least one portion at a first voxel resolution level and another portion at a second voxel resolution level of finer resolution than the first voxel resolution level, and wherein the voxel resolution at each portion of the variable-resolution TSDF grid is based on the level hints;
generating a polygon mesh from the variable-resolution TSDF grid digitally representing surfaces in the real-world environment captured by the image data; and
storing the polygon mesh in a map database.

12. The non-transitory computer-readable storage medium of claim 11, the operations further comprising:
applying an object detection model to each frame to identify one or more objects in the frame; and
tracking one or more of the objects across frames;
wherein generating the variable-resolution TSDF grid is further based on the tracked one or more objects in the real-world environment.

13. The non-transitory computer-readable storage medium of claim 12, wherein the object detection model is trained as a machine-learning model in a supervised manner with training image data labeled with identified objects.

14. The non-transitory computer-readable storage medium of claim 1,
wherein applying the depth estimation model to each frame further comprises applying the depth estimation model to identify surface orientation of one or more surfaces present in the frame; and
wherein generating the variable-resolution TSDF grid is further based on the one or more surface orientations of the one or more surfaces.

15. The non-transitory computer-readable storage medium of claim 1, wherein the depth estimation model is trained as a machine-learning model in a self-supervised manner by projecting frames from training image data onto other frames of the training image data based on depth predictions by the depth estimation model.

16. The non-transitory computer-readable storage medium of claim 11, wherein generating the variable-resolution TSDF grid is constrained by limiting neighboring voxel cells to be at most one voxel resolution level difference.

17. The non-transitory computer-readable storage medium of claim 11, wherein generating the variable-resolution TSDF grid comprises implementing a hyperparameter that sets a quantity of depth predictions fused into the TSDF value per voxel, wherein the hyperparameter is fit to an error curve for depth predictions by the depth estimation model.

18. The non-transitory computer-readable storage medium of claim 11, wherein generating the polygon mesh from the variable-resolution TSDF grid comprises interpolating between neighboring voxels of different voxel resolution levels.

19. The non-transitory computer-readable storage medium of claim 1, the operations further comprising:
augmenting the polygon mesh with patterns from the image data corresponding to one or more surfaces represented by the polygon mesh.

20. The non-transitory computer-readable storage medium of claim 11, the operations further comprising:
receiving a request from a second client device to view the polygon mesh;
retrieving the polygon mesh from the map database; and
transmitting the polygon mesh to the second client device for presentation on the second client device.
